(19) United States
(12) Patent Application Publication
(10) Pub. No.: US 2016/0209293 A1
(43) Pub. Date: Jul. 21, 2016

(54) APPARATUS FOR LEAK DETECTION

(71) Applicant: Hoffmann-La Roche Inc., Little Falls, NJ (US)

(72) Inventors: Joerg Luemkemann, Loerrach (DE); Michel Schaffner, Baden (CH); Sebastian Schneider, Schliengen (DE)

(73) Assignee: Hoffmann-La Roche Inc., Little Falls, NJ (US)

(21) Appl. No.: 15/086,551

(22) Filed: Mar. 31, 2016

Related U.S. Application Data
(63) Continuation of application No. PCT/EP2014/070768, filed on Sep. 29, 2014.

(30) Foreign Application Priority Data
Oct. 2, 2013 (EP) 13187121.2

(51) Int. Cl. G01M 3/24

(52) U.S. Cl. CPC G01M 3/24

(57) ABSTRACT

The invention relates to an apparatus for testing the integrity of packaging containers, comprising a detector (9) for the detection of an ultrasound signal generated by gas flow through a leak in a pressurized packaging container (3), characterized in that the apparatus comprises a test chamber (2) suitable for accommodation of a pressurized packaging container (3) and the detector (9) being arranged such that it is to detect a gas-borne ultrasound signal generated by gas flow through a leak in a pressurized packaging container (3) inside the test chamber (2).

### CROSS REFERENCE TO RELATED APPLICATIONS

This application is a continuation of International Application No. PCT/EP2014/070768, having an international filing date of 29 Sep. 2014, the entire contents of which are incorporated herein by reference, and which claims benefit under 35 U.S.C. 119 to European Patent Application No. 13187121.2, filed 2 Oct. 2013, the entire contents of which are incorporated herein by reference.

### FIELD OF THE INVENTION

The invention relates to an apparatus for integrity testing of empty plastic packaging items before and/or after use as, for example, packaging items for drug substances or drug products. The invention also relates to a method for using the apparatus and to uses of said apparatus.

### BACKGROUND OF THE INVENTION

In pharmaceutical drug manufacturing, plastic packaging is usually designed for single-use application (disposable). The use of disposable containers is an emerging technology because of the risk reduction of cross contamination, the superior transportability, and lower initial investment costs. Amongst others, disposable containers are used for bulk-mixing, bulk-transport operations, for freezing, thawing, and compounding of drug substance solutions or buffer stock solutions. In order to fulfill the different process requirements, disposable containers are used in a broad range of different sizes and designs.

The integrity of the disposable container system is certified by the packaging manufacturer prior to use. The post use integrity is reassured by the pharmaceutical manufacturer at the respective filling site. Currently, the selection of appropriate test methods is mainly based on the experiences made from container closure integrity tests of pharmaceutical products. Here, different methods are established on the market that generally can be divided in two groups: physical and microbial tests.

Microbiological analysis of the packaging content has long been used to verify that pharmaceutical products maintain their sterility and packaging is thus still intact. The sterility of the pharmaceutical product can be an indirect evidence of packaging integrity of disposable containers used in previous manufacturing steps, for example, bulk-mixing, freezing, thawing, and compounding. However, sterility testing has practical limitations as it is, inter alia, destructive, and delayed (i.e. detection of already contaminated samples). Therefore, the exclusive use of this test method for the integrity testing of disposable containers after use can lead to loss of product and therefore financial values. The application of microbial/sterility testing prior to use is excluded as it is destructive.

In microbial challenge tests, package units are immersed into a suspension of microorganisms or sprayed with an aerosol containing microorganisms. Because microbial challenge tests are destructive they are not appropriate for the integrity testing of disposable containers pre use. They are of course a standard for integrity testing after use and alternative test methods are often cross-validated to a microbial challenge study.

Based on this consideration, the packaging manufacturer as well as the pharmaceutical industry is encouraged by the FDA to develop innovative methods for testing the container closure integrity of pharmaceutical packaging items.

These alternatives to sterility testing and microbial challenge tests are mainly physical integrity tests that bring some significant advantages: physical integrity tests can be non-destructive, time efficient, and may detect container defects before contamination can occur. The FDA guidance document “Container and Closure System Integrity Testing in Lieu of Sterility Testing as a Component of the Stability Protocol for Sterile Products” as well as the USP general chapter <1207>“Sterile Product Packaging Integrity” provide a list of test methods that have been established on the market as container closure integrity tests of the pharmaceutical product, some of which can be also applied to disposable containers, including bubble tests, pressure/vacuum decay tests, trace gas permeation/leak tests, dye penetration tests, seal force tests, and electrical conductivity tests.

Pressure/vacuum decay tests measure pressure differences or flow rates caused by gas flow through packaging leaks. This method is a common non-destructive integrity test that is well established for non-porous packaging materials, for example, stainless steel containers. However, in contrast to stainless steel containers disposable containers are plastic and hence non-rigid. Thus, disposable containers expand during testing. This behavior of non-rigid materials depends on volume, material, thickness, age, and history of the disposable container under test. While this effect is controllable for small packaging volumes, it becomes difficult for larger packaging volumes resulting in long measurement times and limited test accuracy.

Bubble tests measure the minimum pressure required for gas penetration through packaging leaks. Because the outer surface of the packaging unit must be in contact with liquid, this test method is not appropriate for integrity testing prior to its use. Furthermore the detection of bubbles depends on the test configuration and the ability of the testing person to detect the leak.

Trace gas permeation/leak tests detect the flow of tracer gas through container leaks. For unfilled disposable containers, this test method can be non-destructive and highly sensitive. However, tracer gas analytics, for example, mass spectrometry and supply of the tracer gas, represents a substantial invest, especially for testing larger packaging volumes.

Electrical conductivity tests detect the presence of conductive solution on the outside of the packaging unit by placing it between two highly charged electrodes. The packaging content will only moisture the outside of the packaging in the presence of packaging leaks and will be detected as a current flow due to a short circuit. Electrical conductivity tests are non-destructive but are restricted to conductive packaging contents and packaging containers composed of non-conductive materials. Therefore, electrical conductivity is not appropriate for integrity testing of unfilled disposable containers pre and after use.

Dye penetration tests and Seal force tests are integrity tests mainly for seal areas and seal strength and are therefore not in scope of this invention.

Further alternative integrity tests have been published in the literature, but have not been recognized or accepted by health care authorities yet. Amongst these are Ultrasonic Imaging and Ultrasonic detection of gas flow.

In Ultrasonic imaging, an ultrasonic transmitter generates ultrasound pulses that are focused on the container surface by acoustic lenses. Because sound scattering, absorption, and reflection depend on the packaging material, the reflected echo provides information about the texture and integrity of the packaging unit under test. Ultrasonic imaging is a fast, gentle, and non-destructive integrity test method. Because this method requires flat surfaces in order to gain a measureable echo, it is commonly used for specific parts of disposable containers, for example, the seal, but is considered inappropriate for the disposable container as a whole.

Ultrasonic detection of gas flow is described for filled containers that can be sealed under pressure or that can be squeezed or otherwise manipulated to create a pressure inside the container. In the presence of packaging defects, gas flows out of leaks and is detected as gas bubbles by a water-coupled ultrasonic receiver, if the container is submerged in water. Because the outer surface of the packaging component must be in contact with liquid this test method is not appropriate for integrity testing of disposable containers prior to its use.

This short review of the prior art shows that the means currently available for the integrity testing of unfilled disposable containers pre and after use are not completely satisfying and still presents many disadvantages.

### SUMMARY OF THE INVENTION

The objective of the invention is to overcome at least some of the drawbacks associated with the prior art and to provide an apparatus and a method which allow the integrity testing of containers or components thereof in accordance with the requirements of the pharmaceutical field.

In a first aspect, the invention relates to an apparatus for the integrity testing of empty packaging items, that can be used to store pharmaceutical products at refrigerated, frozen, ambient, or uncontrolled conditions, before and after use as, for example, packaging of drug substances and drug products, compromising a reverberant test chamber in which the plastic packaging item under test is pressurized. The test chamber is equipped with air-coupled ultrasound sensors that detect the airborne ultrasonic signal that is generated when gas molecules flow through leaks of the item under test.

The present invention relates to an apparatus for testing the integrity of packaging containers, comprising a detector for the detection of an ultrasound signal generated by gas flow through a leak in a pressurized packaging container, characterized in that the apparatus comprises a test chamber suitable for accommodation of a pressurized packaging container, and the detector being arranged such that it is to detect a gas-borne ultrasound signal generated by gas flow through a leak in a pressurized packaging container inside the test chamber.

In a particular embodiment of the apparatus of the invention, the test chamber is configured to be reverberant.

In a particular embodiment of the apparatus of the invention, the test chamber is filled with gaseous medium.

In a particular embodiment of the apparatus of the invention, the test chamber is filled with air.

In a particular embodiment of the apparatus of the invention, the detector is arranged inside the test chamber.

In a particular embodiment of the apparatus of the invention, the detector is arranged such that it is to detect the ultrasound signal through an opening in a wall of the test chamber.

In a particular embodiment of the apparatus of the invention, the packaging container and the test chamber are rotatable relative to each other.

In a particular embodiment of the apparatus of the invention, the test chamber comprises means for receiving the packaging container, and the means for receiving the packaging container are arranged inside the test chamber to be rotatable around an axis.

In a particular embodiment of the apparatus of the invention, the means for receiving the packaging container are a frame which receives the packaging container.

In a particular embodiment of the apparatus of the invention, the apparatus further comprises means for pressurizing the packaging container with a sterile gaseous medium, preferably sterile nitrogen.

In a second aspect, the present invention relates to a method for testing the integrity of packaging containers by detection of an ultrasound signal generated by gas flow through a leak in a pressurized packaging container, characterized in that the pressurized packaging container is accommodated in a test chamber and an airborne ultrasound signal generated inside the test chamber is detected.

In a particular embodiment of the method of the present invention, the packaging container is made of a flexible material.

In a particular embodiment of the method of the present invention, the packaging container is made of plastic.

In a particular embodiment of the method of the present invention, the packaging container is for single use/disposable.

In a particular embodiment of the method of the present invention, the packaging container is sterile.

In a particular embodiment of the method of the present invention, the packaging container is for packaging pharmaceutical materials.

In a particular embodiment of the method of the present invention, the testing is performed prior to use of the packaging container.

In a particular embodiment of the method of the present invention, the testing is performed after use of the packaging container.

Because the airborne ultrasonic signal, which is detected during integrity testing, depends on the inlet pressure and the leak size rather than on volume, material, thickness, age, and history of the sample under test, this method is appropriate for the integrity testing of a broad range of packaging sizes and designs.

Further, the application of air-coupled ultrasonic receivers avoids relevant stress on the package, for example, submerging of the outer surface, so that the test can be performed pre and after use.

By the reverberant design of the test chamber sound absorption is efficiently reduced and thus accurate integrity testing is ensured.

The test procedure of the invention is simple and the measurement time short. Hence, it is appropriate for testing the packaging pre use at the packaging manufacturer as well as after use at the pharmaceutical manufacturer.

Furthermore, because of its unique characteristics, the test procedure of the invention allows a rapid integrity testing of packaging containers pre and after use that are currently not accessible by other physical integrity tests, which leads to a safer drug substance transport, safe compounding of any product, bulk solutions or buffer stock solutions and a safe compounding process compared to integrity testing based on microbiological sterility testing.

### BRIEF DESCRIPTION OF THE DRAWINGS

FIG. 1 shows a schematic overview of the apparatus of the invention. Packaging container under testing are provided with gas from the gas cylinder passing the pressure restrictor. The airborne ultrasound signal caused by turbulent air flow at the leak is detected by an ultrasonic capturing device (sensor) and transmitted to a recording device.

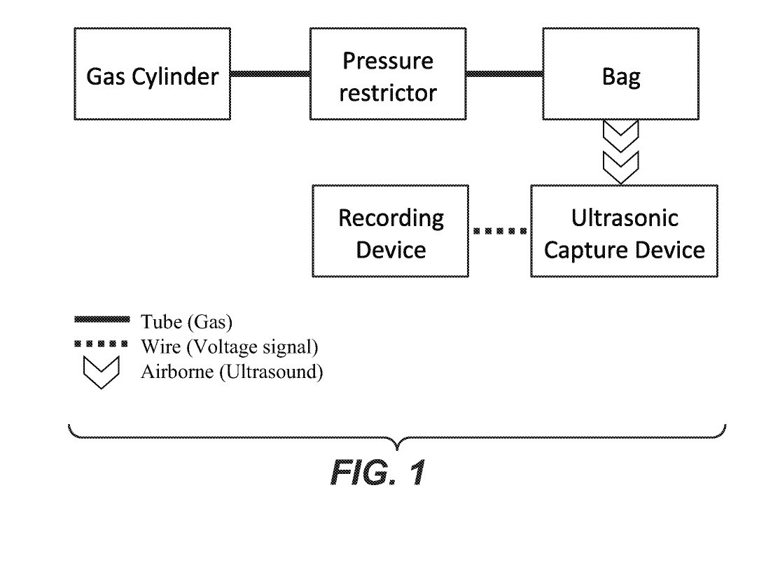

FIG. 2 shows an exploded view of the apparatus of the invention (1). The packaging container or bag (3) to be tested for integrity is mounted to a frame (5). The frame (5) comprises a connecting element (6) and (7) connecting the packaging container (3) to a mounting element (12), linking the gas pipe, gas tube, or gas-providing tube (10) of the apparatus of the invention to the packaging container (3). The apparatus of the invention (1) comprises a test chamber or test barrel (2) and a rotating disk or rotating cover (8) with a hand crank (11). Furthermore, a sensor to detect an ultrasound signal (9) is mounted to the test chamber (2).

FIG. 3 shows the assembled apparatus of the invention (1), with a rotating disk or cover (8) and a hand crank (11), a mounting element (12) and gas pipe (10), and a sensor to detect an ultrasound signal (9).

FIGS. 4A and 4B show the voltage signal from three runs of ultrasonic leak testing using the apparatus of the invention for not punctured (FIG. 4A) and punctured disposable bags (FIG. 4B).

### EXAMPLE 1

### Introduction

Ultrasonic bag (Celsius FFT 12L, Sartorius Stedim Biotech GmbH Goettingen, Germany) testing is performed using the Ultrasonic spy 101 (Richard Chambers GmbH, Heimstetten, Germany) or another ultrasonic sound capture device. Ultrasound is generated by turbulent air flow on the edge of a leak. The pressure needed to get sufficient air flow out of the leak is provided via Flowstar® 3 (Pall AG, Basel, Switzerland) or another device capable to provide a gas at a particular pressure (≦200 mbar). The sound signal captured by an ultrasonic capturing device will be transmitted to an Endress+Hauser Graphic Data Manger RSG40 or another device able to display and record a voltage signal. Bags under testing will be placed in a soundproof steel barrel where they are fitted with springs in a frame which allows the bags to expand. A hand crank allows the frame to get turned in the barrel during signal capturing.

### Components of a Specific Embodiment of the Apparatus of the Invention

Packaging container (3), for example disposable bags
Test chamber (2)
Ultrasound capturing device (9)

A gas cylinder provides the gas to pressurize the packaging container and a pressure restrictor is used to provide the gas at a particular pressure.

Method

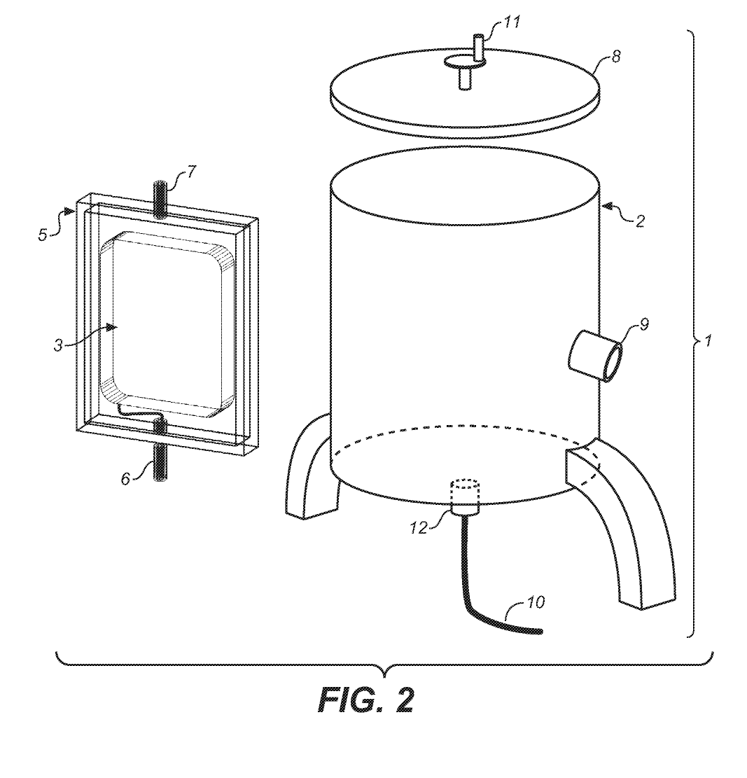

1. Mount the packaging container (3) with springs in the frame (5) (see FIG. 2)

2. Mount the frame (5) in the test barrel (2) and close the cover (8) (see FIG. 2). The top of frame (5) is releasable and pivotally connected to the rotating disc (8) by connecting element (7) and the lower end of frame (5) is releasable and pivotally connected by connecting element (6) to a mounting element (12) which connects frame (5) to gas tube (10). The connecting element (6) is in form of a hollow tube to allow connection of the packaging container (3) to the gas pipe (10).

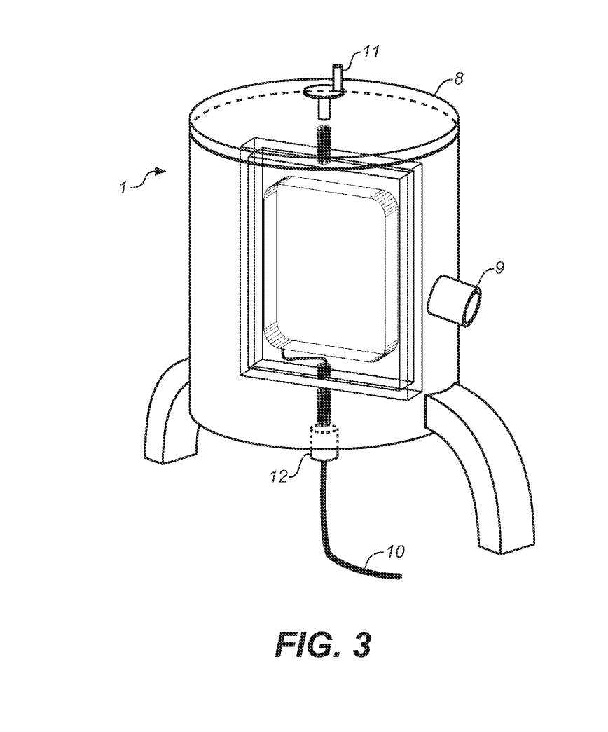

3. Install the pressure restrictor (Flowstar or similar device) and connect the gas providing tube (10) through the duct at the bottom of the test chamber (2) to the frame (5) (see FIG. 3). The packaging container (3) has to be under pressure during the ultrasound measurement.

4. Install the recording device (RSG40 Graphic Data Manager or similar recording device)

5. Install the ultrasound capturing device (Ultrasonic spy 101 or similar device) at the measuring position and connect to the recording device

6. Start pressure restricting device and wait until intended pressure is reached

7. Start ultrasound capturing device and turn the frame (5) containing the bag (3) two times slowly with the hand crank (11) of the rotating disc (8) at 1 full rotation per 30 s while recording.

Results

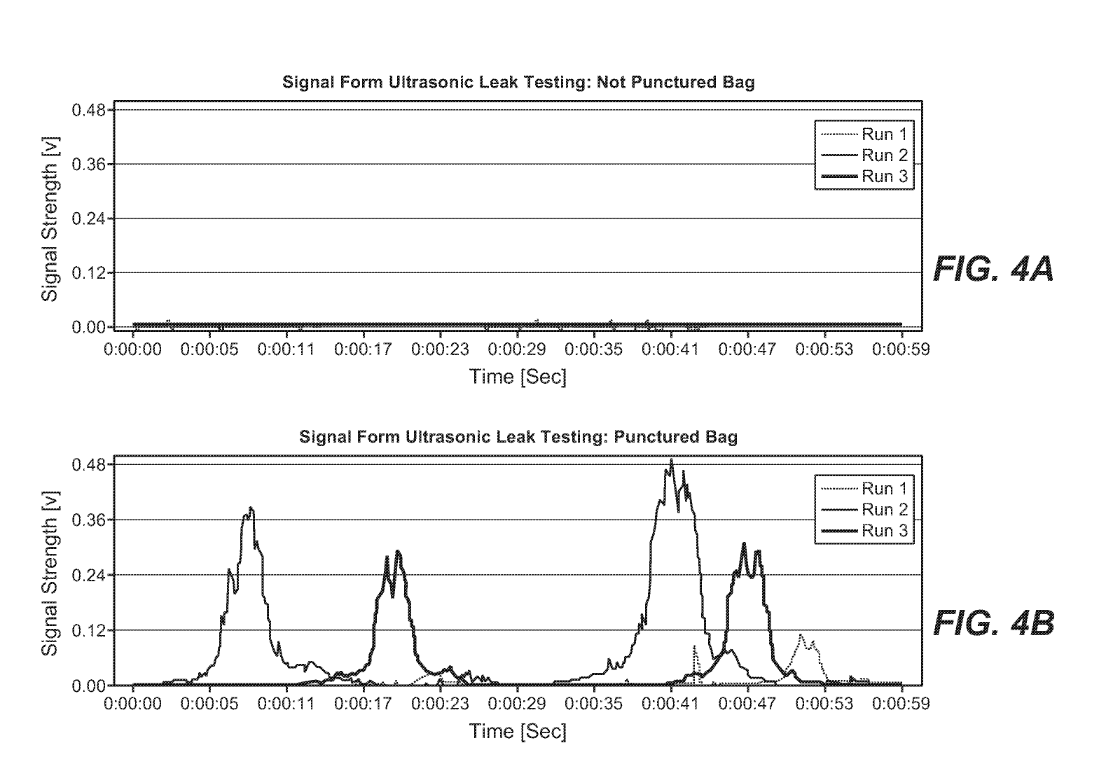

FIGS. 4A and 4B show the voltage signal form ultrasonic leak testing in not punctured and punctured disposable bags. FIG. 4A, not punctured bags show no signal; FIG. 4B, punctured bags show a signal with two peaks coming from turning the bag two times within 60 seconds around the y-axis. Signals were measured using the above described apparatus and method.

What is claimed is:

1. An apparatus (1) for testing the integrity of a packaging container (3), wherein the apparatus comprises a test chamber (2) and an ultrasonic capturing sensor or detector (9), wherein the sensor is for the detection of an ultrasound signal, and wherein the test chamber is suitable for accommodation of a pressurized packaging container, and further wherein the sensor or detector is arranged to detect a gas-born ultrasound signal generated by gas flow through a leak in the pressurized packaging container located inside the test chamber.

2. The apparatus of claim 1, wherein the packaging container (3) is in a frame (5).

3. The apparatus of claim 2, wherein the frame comprises a first connecting element (6) and a second connecting element (7).

4. The apparatus of claim 3, wherein the connecting elements connect the packaging container to a mounting element (12).

5. The apparatus of claim 4, wherein a gas pipe (10) is connected to the mounting element.

6. The apparatus of any one of claims 1-5, wherein the packaging container is capable of being pressurized with a gaseous medium.

7. The apparatus of claim 6, wherein the means for pressurizing the packaging container are the connecting element and the gas pipe.

8. The apparatus of claim 1, wherein the test chamber is configured to be reverberant.

9. The apparatus of claim 1, wherein the test chamber is filed with a gaseous medium.

10. The apparatus of claim 1, wherein the test chamber is filled with air.

11. The apparatus of claim 1, wherein the sensor or detector is positioned inside of the test chamber.

12. The apparatus of claim 1, wherein the sensor or detector is positioned to detect the ultrasound signal through an opening in a wall of the test chamber.

13. The apparatus of claim 1, wherein the test chamber comprises a means for receiving the packaging container, wherein the means for receiving the packaging container is arranged inside the test chamber to be rotatable around an axis.

14. The apparatus of claim 13, wherein the packaging container and the test chamber are rotatable relative to each other.

15. The apparatus of claim 13, wherein the means for receiving the packaging container is a frame which receives the packaging container.

16. A method for testing the integrity of a packaging container using the apparatus in claim 1, the method comprising positioning the packaging container within the test chamber, pressurizing the test chamber such that the packaging container is pressurized, and detecting an ultrasound signal generated by gas flow through a leak in the pressurized packaging container.

17. The method of claim 16, wherein the packaging container is made of a flexible material.

18. The method of claim 16, wherein the packaging container is made of plastic.

19. The method of claim 16, wherein the packaging container is for single use.

20. The method of claim 16, wherein the packaging container is sterile.

21. The method of claim 16, wherein the packaging container is for packaging a pharmaceutical material.

22. The method of claim 16, wherein the testing of the packaging container is performed prior to use of the packaging container.

23. The method of claim 16, wherein the testing of the packaging container is performed after use of the packaging container.
